(19) United States
(12) Patent Application Publication
(10) Pub. No.: US 2020/0070217 A1
(43) Pub. Date: Mar. 5, 2020

(54) AIR CONDITIONER (A/C) CONDENSATE LINE DOSING DEVICE, SYSTEM AND ASSOCIATED METHODS

(71) Applicant: Logan Rose, Orlando, FL (US)

(72) Inventor: Logan Rose, Orlando, FL (US)

(21) Appl. No.: 16/115,925

(22) Filed: Aug. 29, 2018

(51) Int. Cl. B08B 9/032; F24F 13/22

(52) U.S. Cl. CPC B08B 9/0325; F24F 13/222

(57) ABSTRACT

An A/C condensate line dosing device includes a frame, a pump having a supply port configured to be coupled to and access a container of algaecide, and a dosing port configured to be coupled to an A/C condensate line. A power unit, such as a battery unit, provides power to the device. A control unit is configured to operate the device in a plurality of phases including a power saving phase and a periodic dosing phase to control the at least one pump to dose the A/C condensate line with the algaecide. A communication interface may be coupled to the control unit and configured to communicate with an external monitoring device. The power saving phase of the control unit may include a deep sleep phase so that the dosing device consumes less than 1% of available power of the battery power unit per day.

### FIELD OF THE INVENTION

The present invention relates to the field of air conditioners, and more particularly, to devices, systems and methods for treating or dosing the condensate line of an air conditioning system.

### BACKGROUND OF THE INVENTION

A centralized air conditioner (A/C) for residential and commercial properties produces condensate as a byproduct from cooling humid air which may be drawn from outside the facility by the central A/C. A condensate drain line or conduit collects this byproduct for conveyance outside of the facility to an area (e.g. a lawn) or other system, such as a sewer or wastewater system.

A common problem with centralized A/C systems is the clogging of condensate drain lines. Organic matter such as mold and/or algae can build up over time, due to the warm and wet condition within the condensate drain line. The buildup will eventually cause the A/C system to malfunction and fail. Typically, central A/C systems include a sensor (e.g., a float sensor) that will shut down the A/C system until the drain line is unclogged and treated. This approach protects against a catastrophic failure of the A/C system.

When the A/C system shuts down, the condensate drain line is required to be manually cleaned. This can require the use of mechanical devices such as hoses or snakes to be inserted into the drain line to remove the obstruction. Other approaches include blowing air into the drain line, creating suction at one end of the drain line, or introducing various chemicals into the drain line in an attempt to dissolve or break up the obstruction. Many times this will require the services of an A/C technician.

Also, removing an obstruction in the drain line through manual efforts does not prevent future clogs. Indeed, the clogs will return as long as the same conditions exist (i.e., humidity and warm temperatures). Thus, periodic manual maintenance of these A/C drain lines may require annual expenses for service technicians especially in humid and warm climates like the Southeast United States.

A typical home treatment for A/C condensate drain lines is to use a solution of vinegar or bleach, or to use a biocide like Benzyl Ammonium Chloride (also known as Benzalkonium chloride, BZK, BKC, BAC, and ADBAC). Some of these treatments include the use of tablets which may be placed within the condensate pan, or the use of liquid solutions added to the drain line which may create safety hazards or lead to corrosion of the pan or drain line.

U.S. Pat. No. 9,943,778 to Gutierrez et al. is directed to a module that is coupled with a condensate drain line downstream from the drip pan. The module includes a biocidal cartridge that sterilizes incoming condensate, and a load cell for continuously weighing the biocide so that a user can determine when it is nearing depletion.

Accordingly, there may be a need to routinely and automatically treat condensate drain lines and avoid the need for service technicians. The automatic treatment approach should accurately dose the A/C condensate drain line with an algaecide and reliably use low power while avoiding the use of external power or any wired, potentially dangerous or warranty concerning, connections with the A/C unit. Avoiding the use of measurement sensors while also providing basic troubleshooting capabilities and user notifications may also be desired.

This background section is intended to introduce the reader to various aspects of typical technology that may be related to various aspects or embodiments of the present invention, which are described and/or claimed below. This discussion is believed to be useful in providing the reader with background information to facilitate a better understanding of the various aspects and embodiments of the present invention. Accordingly, it should be understood that these statements are to be read in light of, and not as admissions of, the prior art.

### SUMMARY OF THE INVENTION

It is may be an objective of the present embodiments to provide an automated treatment approach for accurately dosing an A/C condensate drain line with an algaecide while reliably using low power and avoiding the use of external power or any wired connections with the A/C unit. It may also be an objective to avoid the use of measurement sensors while also providing basic troubleshooting capabilities and user notifications.

This and other objects, advantages and features in accordance with the present embodiments may be provided by an A/C condensate line dosing device including a frame, at least one pump carried by the frame and including a supply port configured to be coupled to and access a container of algaecide, and a dosing port configured to be coupled to an A/C condensate line. A control unit is carried by the frame and coupled to the at least one pump, and a power unit is carried by the frame and configured to provide power to the at least one pump, the communication interface and the control unit. The control unit is configured to operate in a plurality of phases including a power saving phase and a periodic dosing phase to control the at least one pump to dose the A/C condensate line with the algaecide.

Additionally, or alternatively, the pump is a positive displacement pump such as a peristaltic pump. Also, the at least one pump may include multiple pumps such as first and second peristaltic pumps configured for use with dual A/C condensate lines.

Additionally, or alternatively, the frame is a housing, and an associated attachment device is configured to attach the housing to an A/C unit and/or the container of algaecide.

Additionally, or alternatively, a wired or wireless communication interface may be coupled to the control unit and configured to communicate with an external monitoring device.

Additionally, or alternatively, one or more environmental sensors (e.g. a temperature sensor and/or a humidity sensor) are carried by the frame and configured to provide environmental data to the control unit.

Additionally, or alternatively, the power unit is a battery power unit, and the power saving phase of the control unit includes a deep sleep phase so that the dosing device consumes less than 1% of available power of the battery power unit per day.

Objects, advantages and features in accordance with the present embodiments may also be provided by an A/C condensate line dosing system including a dosing device having a housing and an associated attachment device (e.g. a magnetic attachment device) configured to attach the housing to an A/C unit. At least one peristaltic pump is carried by the housing and includes a supply port and a dosing port. A supply conduit is coupled to the supply port and configured to access an algaecide container (e.g. a separate container of vinegar). A dosing conduit is coupled to the dosing port and configured to provide an A/C condensate line with algaecide via the at least one peristaltic pump. A control unit is carried by the housing and coupled to the at least one peristaltic pump. A wireless communication interface (e.g. via WiFi, Bluetooth, NFC, cellular, etc.) is coupled to the control unit and configured to communicate with an external monitoring device (e.g. a computer or mobile smart device), and a battery power unit is carried by the housing and configured to provide power to the at least one peristaltic pump, the communication interface and the control unit. The control unit is configured to operate in a deep sleep power saving phase and a periodic dosing phase to control the at least one pump to dose the A/C condensate line with the algaecide. The deep sleep power saving phase is configured so that the dosing device consumes less than 1% of available power of the battery power unit per day. An application software is configured to be installed and operate on the external monitoring device, and configured to exchange data with the control unit via the wireless communication interface.

Additionally, or alternatively, the at least one peristaltic pump includes first and second peristaltic pumps configured for use with dual A/C condensate lines.

Additionally, or alternatively, the device includes one or more environmental sensors carried by the housing and configured to provide environmental data to the control unit. The one or more environmental sensors may be temperature sensors and humidity sensors.

Additionally, or alternatively, the application software is configured to notify a user of dosing device issues via electronic notifications including at least one of text, email and mobile application notifications. The application software may include a graphical user interface that displays at least one of temperature data, humidity data, battery data and algaecide data.

Additionally, or alternatively, the control unit is configured to sense current draw of the at least one peristaltic pump and provide pump status data to the application software.

Objects, advantages and features in accordance with the present embodiments may also be provided by an automated method of dosing at least one A/C condensate line of an A/C system to prevent algae growth therein. The method includes: providing at least one peristaltic pump coupled between a container of algaecide and the A/C condensate line; coupling a control unit to the at least one peristaltic pump; coupling a communication interface to the control unit and configured to communicate with an external monitoring device; and providing battery power to the at least one peristaltic pump, the communication interface and the control unit. The control unit is configured to operate in a plurality of phases including a power saving phase and a periodic dosing phase to control the at least one pump to dose the A/C condensate line with the algaecide.

Additionally, or alternatively, the at least one peristaltic pump includes first and second peristaltic pumps configured for use with dual A/C condensate lines.

Additionally, or alternatively, the peristaltic pump, control unit and communication interface are carried by a housing, and the method includes magnetically attaching the housing to an A/C unit.

Additionally, or alternatively, the method includes providing environmental data to the control unit using at least one environmental sensor, wherein the environmental sensor comprises at least one of a temperature sensor and a humidity sensor.

Additionally, or alternatively, the power saving phase of the control unit includes a deep sleep phase so that the at least one peristaltic pump, control unit and communication interface consume less than 1% of available power of the battery power unit per day.

So, the system and device can operate off battery power for extended periods of time do to the utilization of low power (deep sleep) options of the control unit. The device does not require external power or any wired, potentially dangerous or warranty concerning, connections with the A/C unit. The system, device and method use a precision pump (e.g. peristaltic pump) for accurate dosing. Other sensors for measuring the remaining amount of algaecide are not needed, and a simple subtraction approach may be used.

### BRIEF DESCRIPTION OF THE DRAWINGS

FIG. 1 is a perspective view illustrating an A/C condensate line dosing system in accordance with features of the present embodiments.

FIG. 2 is a perspective view illustrating an embodiment of the A/C condensate line dosing device of the system of FIG. 1, with a portion of the housing cut away, in accordance with features of the present embodiments.

FIG. 3 is a schematic diagram illustrating an embodiment of the circuit and component layout of the A/C condensate line dosing system of FIG. 1.

FIG. 4 is a screen shot illustrating an embodiment of the graphical user interface (GUI) for an application running on the user device of FIG. 3.

### DETAILED DESCRIPTION OF THE PREFERRED EMBODIMENTS

The present invention will now be described more fully hereinafter with reference to the accompanying drawings in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. The dimensions of layers and regions may be exaggerated in the figures for greater clarity.

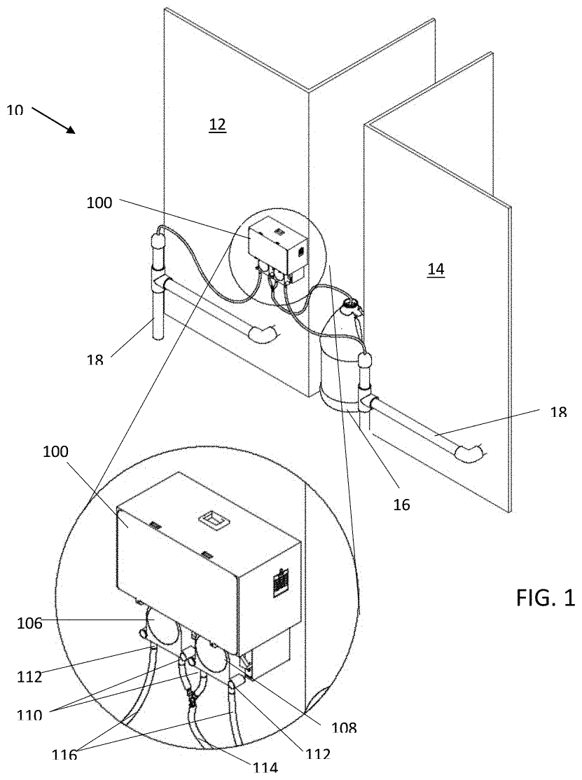

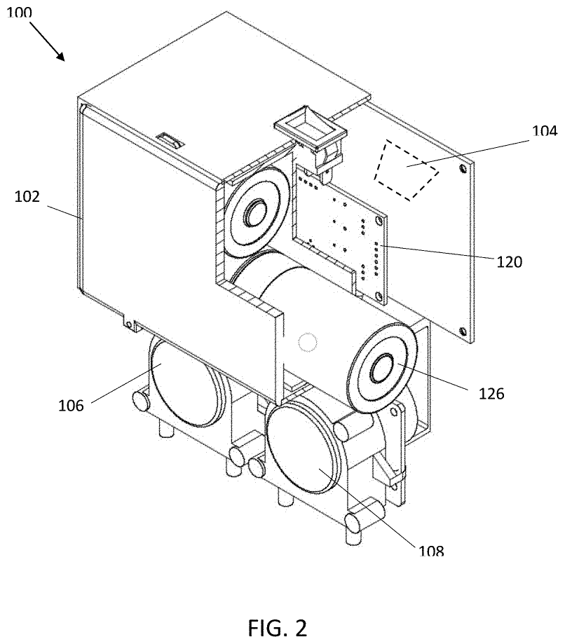

Referring now to FIGS. 1-4, an A/C condensate line dosing system 10 in accordance with features of the present embodiments will now be described. As illustrated, the A/C condensate line dosing system 10 includes a dosing device 100 having a frame or housing 102 and an associated attachment device 104 (e.g. a magnetic attachment device, tape, or any other mechanical fastener) configured to attach the housing 102 to an A/C unit 12 or 14.

One or more peristaltic pumps 106 and 108 are carried by the housing 102. As illustrated, the peristaltic pumps 106 and 108 are configured for use with dual A/C condensate lines 18. However, as would be appreciated, a single pump may be used with a single A/C unit. Furthermore, a peristaltic pump is an example of a pump, specifically a positive displacement pump, that may be used in the present embodiments. Other types of pumps may also be used such as a differential pressure type or rotary vane type pump.

The pumps 106 and 108 each include a supply port 110 and a dosing port 112. A supply conduit 114 is coupled to the supply port 110 and configured to access an algaecide container 16 (e.g. a separate container of vinegar). 5. A third-party algaecide container may be used (e.g. nontoxic vinegar example) that is readily available at local retailers. A dosing conduit 116 is coupled to the dosing port 112 and configured to provide the A/C condensate line 18 with algaecide via one of the peristaltic pumps 106 and 108.

A control center 120 including a control unit 122 is carried by the housing 102 and coupled to the peristaltic pumps 106 and 108. The control center 120 may include components mounted on a printed circuit board as would be appreciated by those skilled in the art.

A wireless communication interface 124 (e.g. via WiFi, Bluetooth, NFC, cellular, etc.) is coupled to the control unit 122 and configured to communicate with an external monitoring device 200 (e.g. a computer or mobile smart device), for example, via a wireless network 128. A power unit 126 (e.g. a battery power unit) is carried by the housing 102 and configured to deliver or provide power to the peristaltic pumps 106 and 108, the communication interface 124 and the control unit 122. The power unit 126 may be a local power supply or a wired or wireless power interface such as a plug, connector, transformer and/or electrical cable, for example.

The control unit 122 is configured to operate the device 100 in a deep sleep power saving phase and a periodic dosing phase to control the pumps 106 and 108 to dose the A/C condensate line 18 with the algaecide from container 16. The deep sleep power saving phase is configured so that the dosing device 100 consumes less than 1% of available power of the battery power unit 126 per day. Preferably, the deep sleep power saving phase is configured so that the dosing device 100 consumes even less than 0.3% of available power of the battery power unit 126 per day.

For example, in the deep sleep power saving phase, the control unit 122 operates according to a program running on a processor, e.g. a code driven command that is programmed into a computer chip that facilitates a deep sleep, low power mode. Of course, many computer chip manufacturers design specific chips that have the ability to go into a low power state to save energy. These chips often have various levels of power saving to address what a user needs. Examples of such power saving features include the ability to turn off the wireless radio communication, turn off external on-board communication to the chip, turn off internal computer processing that is executed via coding, turn off internal timers that require processing power, and to turn off brown out detection (BOD) or other power monitoring modules on the chip itself.

In the present example embodiment, just before the low power mode execution, the chip saves any needed information. More specifically, the chip may save information regarding counters used for the device 100, or options that the user may have selected on an external application, onto on-board device storage. Once entering the low power mode, the chip may only manage a single internal counter to save processing power and usage. Because some chips may have a limited time (maximum amount of time) that they can be in a low power state and retain information set from the user, the chip needs to wake up at the determined time (e.g., after one hour of deep sleep) and execute some remaining code. If it is determined that the chip should sleep longer (i.e., go back into deep sleep), it updates the counters saved in storage to reflect the new value (e.g., count +1), and then goes back into deep sleep. This process only takes milliseconds while still keeping selected processes turned off (e.g., wireless radio, other counters, external connections etc.). The result is a very low use of power. Indeed, the power usage can be even lower than a battery's natural power degrade over time, more commonly known as “shelf life”.

An example of this approach is to have a chip with a maximum deep sleep mode time of 1 hour, and tasked with performing an operation daily, to go into the deep sleep mode followed by a wake up twenty-three, or twenty-four times daily and keep a record (e.g., via a counter) of how many times it has entered this phase, as a determining factor on when a twenty-four hour day has passed. A time sync feature could also be implemented over a network (e.g., the internet) to accurately update the chip's clock periodically.

Alternatively, some chips have the ability to sleep for days, weeks, or even years. While they may be easier to include a deep sleep mode process, they may be more expensive and therefore increase the cost of the computer chip and the device 100. In other words, such chips may be less attractive for mass production needs.

The device 100 includes one or more environmental sensors 130 included with the control center 120 and carried by the housing 102. The sensors 130 are configured to provide environmental data to the control unit 122. The one or more environmental sensors 130 may be temperature sensors and humidity sensors.

The control unit 122 may be configured to sense current draw of the peristaltic pumps 106 and 108 and provide pump status data, for example, to an application software running on the user device 200 and described in further detail below. The device 100 may include a power monitoring module 132 or sensor to monitor current, voltage, and amperage to determine motor trouble. If a DC motor returns a zero value, or below a set threshold, then the power monitoring module will notify a user of a critical motor fault/failure. If a DC motor returns a value above a set threshold, it will notify the user that the motor is stuck or experiencing current draw above the operating parameters. This data can also help with servicing the system 10 and device 100 because a vendor will have access to the data from the customer notification.

A INA219 (DC high side current sensor) over a I2C protocol may be used for the power monitoring. A voltage divider system (e.g. a system using two resistors to lower the voltage enough for the control unit 122 (e.g. microprocessor) to accept it as an analog signal). Such a voltage divider is can detect the battery level as would be appreciated by those skilled in the art.

A power regulator 134 and a status light or LED 136 may also be included in the control center 120 of the device 100. The power regulator 134 or voltage regulator is a unit designed to automatically maintain a constant voltage level. The regulator 134 may use a simple feed-forward design or may include negative feedback. It may use an electromechanical mechanism, or electronic components. Depending on the desired requirements, the regulator 134 may be used to regulate one or more AC or DC voltages. The status light or LED 136 may be used as a low-cost approach for an output component of the control center 120 to provide various feedback to the user. The status light/LED 136 is an example of an output component that may provide output information from device 100 (e.g., a display, a speaker, one or more light-emitting diodes (LEDs), etc.).

A preferred operation sequence of the device 100 as controlled by the control unit 122, and referring to hourly, daily and weekly operations as examples, includes dividing cycles into an hourly sleep mode schedule (e.g., twenty-four cycles), making the daily process straightforward to calculate, weekly cycles (e.g., seven times the daily cycle), and so on. For example, this may be preferred for an approach where the user needs to dose the condensate line 18 twice per month to achieve the desired results. This may be the preferred approach for the embodiment that includes a wireless communication device.

Another embodiment, which may use a non-wireless communication chip (e.g., the common ATmega32p chip from Atmel®, commonly used in Arduino devices) includes a sleep mode of the maximum allotted time of just eight seconds. Simple formulas may determine how many of these sleep cycles are needed before the chip needs to complete the task. Although eight seconds may not seem significant, when calculated into the chip cycle speed (e.g., using a milliseconds format), the chip may only be “awake” (i.e., non-sleep or “low power” mode) for 0.0125% of the time, thus resulting in a significant reduction in power usage.

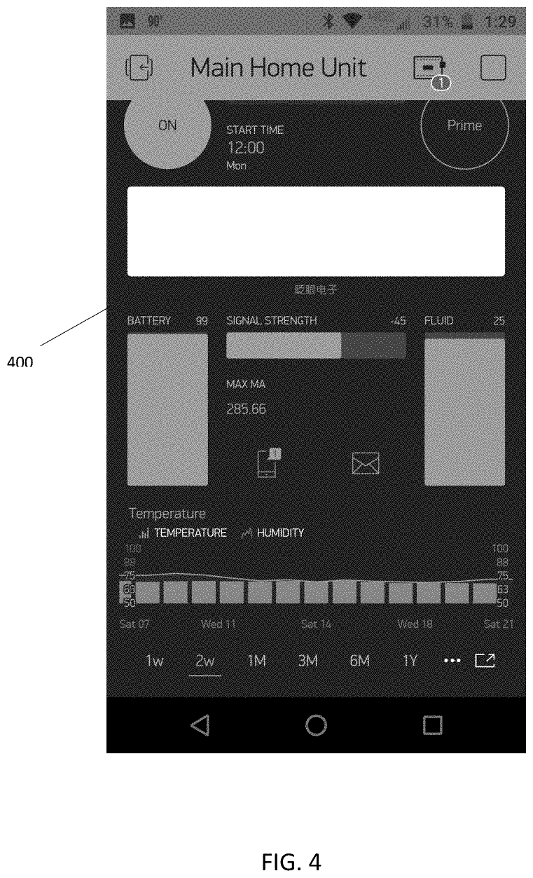

Application software is configured to be installed and operate on the user device 200 which is defined as an external monitoring device. The application is configured to exchange data with the control unit 122 via the wireless communication interface 124. The application software is configured to notify a user of dosing device 100 issues via electronic notifications including at least one of text, email and mobile application notifications. The application software may include a graphical user interface 400 (FIG. 4) that displays at least one of temperature data, humidity data, battery data and algaecide data. 4. The use of temperature and humidity may be graphed out on the user application GUI 400, so it is easy for user to see any changes from day to day operation. The dosing application may show one year of data history to the user, for example, and may also allow the user to set start and end times of the dosing operation.

Text messaging, or texting, is the act of composing and sending electronic messages between two or more mobile phones or fixed or portable devices over a phone network. Text messaging may include the use of Short Message Service (SMS) or multimedia messages (known as MMS) containing images, videos, and sound content, as well as ideograms known as emoji. Instant messaging is a set of communication technologies used for text-based communication between two or more participants over the Internet or other types of networks.

Electronic mail (email) is a method of exchanging digital messages between computer users. Email operates across computer networks, now primarily the Internet. Today's email systems are based on a store-and-forward model. Email servers accept, forward, deliver, and store messages. Neither the users nor their computers are required to be online simultaneously; they need connect only briefly, typically to a mail server, for as long as it takes to send or receive messages. Originally an ASCII text-only communications medium, Internet email was extended by Multipurpose Internet Mail Extensions (MIME) to carry text in other character sets and multi-media content attachments.

The user device 200 may be a mobile communication device and may be operative to communicate using a variety of communication networks and protocols other than those used for communication through a private and/or local network. For example, the mobile device may be additionally or alternatively configured for data communication through a wireless communication link such as a Wi-Fi link. Mobile devices communicating through Wi-Fi communication links may access Internet-connected servers and services directly through the Internet, and/or access servers and services provided by a carrier of a mobile wireless network via the Internet and/or a private network operated by the carrier.

The mobile wireless network may include one or more wired and/or wireless networks or connections. For example, the network may include a cellular network (e.g., a long-term evolution (LTE) network, a 3G network, or a code division multiple access (CDMA) network), a public land mobile network (PLMN), a local area network (LAN) (e.g., a Wi-Fi network), a wide area network (WAN), a metropolitan area network (MAN), a telephone network (e.g., the Public Switched Telephone Network (PSTN)), a private network, an ad hoc network, a wired connection, a wireless connection (e.g., a Bluetooth connection or a near field communication connection), or the like, and/or a combination of these or other types of networks or connections.

The number and arrangement of devices and networks are provided as an example. In practice, there may be additional devices and/or networks, fewer devices and/or networks, different devices and/or networks, or differently arranged devices and/or networks than those shown or described. Furthermore, two or more devices may be implemented within a single device, or a single device may be implemented as multiple, distributed devices. Additionally, or alternatively, a set of devices (e.g., one or more devices) may perform one or more functions described as being performed by another set of devices.

The mobile device of a user can receive applications through the networks, such as an A/C condensate line dosing application and/or other applications, and execute the applications written in various programming languages. Such a mobile device can be a portable handset, smartphone, or personal digital assistant, although they may be implemented in other forms. For example, the mobile device can be a tablet computer, such as an iPad, or other computing device configured for communication through a mobile wireless communication network and/or other types of wireless communication links. Program applications, including the present A/C condensate line dosing application, can be configured to execute on many different types of mobile devices. For example, a mobile device application can be written to execute on a Windows Mobile based mobile device, Android, iPhone, Java Mobile, or Blackberry based mobile device.

A typical mobile device may include a bus, a processor, a memory, a storage component, an input component, an output component, a communication interface and/or a display, as would be appreciated by those skilled in the art.

In the control center 120, the control unit 122 may be referred to as an integrated circuit chip or processor which may be implemented in hardware, firmware, or a combination of hardware and software. Such a processor may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, the processor may include one or more processors capable of being programmed to perform a function. An associated memory may include a random access memory (RAM), a read only memory (ROM), and/or another type of dynamic or static storage device (e.g., a flash memory, a magnetic memory, an optical memory, etc.) that stores information and/or instructions for use by the processor.

Communication interface may include a transceiver-like component (e.g., a transceiver, a separate receiver and transmitter, etc.) that enables device 100 to communicate with other devices, such as via a wired connection, a wireless connection, or a combination of wired and wireless connections. Communication interface may permit device 100 to receive information from another device and/or provide information to another device. For example, communication interface may include an Ethernet interface, an optical interface, a coaxial interface, an infrared interface, a radio frequency (RF) interface, a universal serial bus (USB) interface, a Wi-Fi interface, a cellular network interface, or the like.

Device 100 may perform one or more processes described herein. Device 100 may perform these processes in response to control unit 122 executing software instructions stored by a non-transitory computer-readable medium. A computer-readable medium is defined herein as a non-transitory memory device. A memory includes memory space within a single physical storage device or memory space spread across multiple physical storage devices.

Software instructions may be read into a memory from another computer-readable medium or from another device via communication interface 124. When executed, software instructions may cause control unit 122 or processor to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

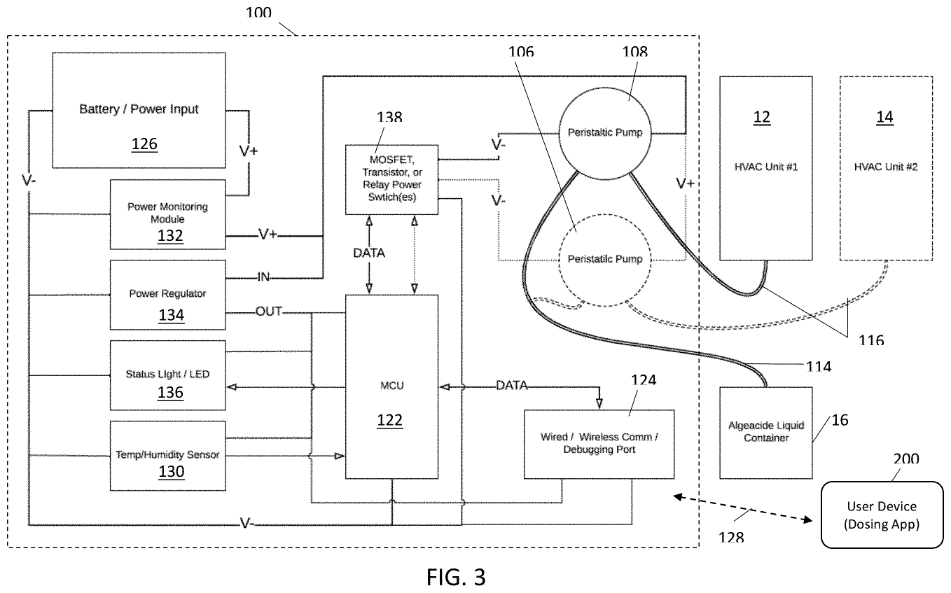

The number and arrangement of components shown in FIG. 3 are provided as an example. In practice, device 100 may include additional components, fewer components, different components, or differently arranged components than those shown in FIG. 3. Additionally, or alternatively, a set of components (e.g., one or more components) of device 100 may perform one or more functions described as being performed by another set of components of device 100.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

It should be noted that the steps described in the method of use can be carried out in many different orders according to user preference. The use of “step of” should not be interpreted as “step for”, in the claims herein and is not intended to invoke the provisions of 35 U.S.C. § 112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As may be used herein, the terms “substantially” and “approximately” provides an industry-accepted tolerance for its corresponding term and/or relativity between items. Such an industry-accepted tolerance ranges from less than one percent to fifty percent. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

As may also be used herein, the terms “processor”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. An A/C condensate line dosing device comprising:
a frame;
at least one pump carried by the frame and including a supply port configured to be coupled to and access a container of algaecide, and a dosing port configured to be coupled to an A/C condensate line;
a control unit carried by the frame and coupled to the at least one pump; and
a power unit carried by the frame and configured to provide power to the at least one pump, the communication interface and the control unit;
the control unit being configured to operate in a plurality of phases including a power saving phase and a periodic dosing phase to control the at least one pump to dose the A/C condensate line with the algaecide.

2. The A/C condensate line dosing device according to claim 1, wherein the at least one pump comprises a positive displacement pump.

3. The A/C condensate line dosing device according to claim 2, wherein the positive displacement pump comprises a peristaltic pump.

4. The A/C condensate line dosing device according to claim 1, wherein the at least one pump comprises first and second peristaltic pumps configured for use with dual A/C condensate lines.

5. The A/C condensate line dosing device according to claim 1, wherein the frame comprises a housing and an associated attachment device configured to attach the housing to at least one of an A/C unit and the container of algaecide.

6. The A/C condensate line dosing device according to claim 1, further comprising a communication interface coupled to the control unit and configured to communicate with an external monitoring device.

7. The A/C condensate line dosing device according to claim 1, further comprising at least one environmental sensor carried by the frame and configured to provide environmental data to the control unit.

8. The A/C condensate line dosing device according to claim 7, wherein the at least one environmental sensor comprises a temperature sensor and a humidity sensor.

9. The A/C condensate line dosing device according to claim 1, wherein the power unit comprises a battery power unit; and wherein the power saving phase of the control unit comprises a deep sleep phase so that the dosing device consumes less than 1% of available power of the battery power unit per day.

10. An A/C condensate line dosing system comprising:
a dosing device including
a housing and an associated attachment device configured to attach the housing to an A/C unit,
at least one peristaltic pump carried by the housing and including a supply port and a dosing port,
a supply conduit coupled to the supply port and configured to access an algaecide container,
a dosing conduit coupled to the dosing port and configured to provide an A/C condensate line with algaecide via the at least one peristaltic pump,
a control unit carried by the housing and coupled to the at least one peristaltic pump,
a wireless communication interface coupled to the control unit and configured to communicate with an external monitoring device, and
a battery power unit carried by the housing and configured to provide power to the at least one peristaltic pump, the communication interface and the control unit,
wherein the control unit is configured to operate in a deep sleep power saving phase and a periodic dosing phase to control the at least one pump to dose the A/C condensate line with the algaecide,
wherein the deep sleep power saving phase is configured so that the dosing device consumes less than 1% of available power of the battery power unit per day; and
an application software configured to be installed and operate on the external monitoring device, and configured to exchange data with the control unit via the wireless communication interface.

11. The system according to claim 10, wherein the at least one peristaltic pump comprises first and second peristaltic pumps configured for use with dual A/C condensate lines.

12. The system according to claim 10, wherein the device further comprises at least one environmental sensor carried by the housing and configured to provide environmental data to the control unit; and wherein the at least one environmental sensor comprises at least one of a temperature sensor and a humidity sensor.

13. The system according to claim 10, wherein the application software is configured to notify a user of dosing device issues via electronic notifications including at least one of text, email and mobile application notifications.

14. The system according to claim 10, wherein the application software includes a graphical user interface that displays at least one of temperature data, humidity data, battery data and algaecide data.

15. The system according to claim 10, wherein the control unit is configured to sense current draw of the at least one peristaltic pump and provide pump status data to the application software.

16. An automated method of dosing at least one A/C condensate line of an A/C system to prevent algae growth therein, the method comprising:
providing at least one peristaltic pump coupled between a container of algaecide and the A/C condensate line;
coupling a control unit to the at least one peristaltic pump;
coupling a communication interface to the control unit and configured to communicate with an external monitoring device; and
providing battery power to the at least one peristaltic pump, the communication interface and the control unit;
the control unit being configured to operate in a plurality of phases including a power saving phase and a periodic dosing phase to control the at least one pump to dose the A/C condensate line with the algaecide.

17. The method according to claim 16, wherein the at least one peristaltic pump comprises first and second peristaltic pumps configured for use with dual A/C condensate lines.

18. The method according to claim 16, wherein at least one peristaltic pump, control unit and communication interface are carried by a housing; and further comprising magnetically attaching the housing to an A/C unit.

19. The method according to claim 16, further comprising providing environmental data to the control unit using at least one environmental sensor; wherein the at least one environmental sensor comprises at least one of a temperature sensor and a humidity sensor.

20. The method according to claim 16, wherein the power saving phase of the control unit comprises a deep sleep phase so that the at least one peristaltic pump, control unit and communication interface consume less than 1% of available power of the battery power unit per day.
